(19) United States
(12) Patent Application Publication
(10) Pub. No.: US 2019/0181797 A1
(43) Pub. Date: Jun. 13, 2019

(54) Smart power supply system

(71) Applicants: Xiangxing Zeng, Shenzhen (CN); Baofeng Miao, Shenzhen (CN); Xiaodan Li, Shenzhen (CN); Wu Chen, Shenzhen (CN); Xiaofei Zou, Shenzhen (CN); Xiang Zhang, Shenzhen (CN); Zhaojun Ye, Shenzhen (CN); Huatan Wu, Shenzhen (CN); Wenliang Chen, Shenzhen (CN); Lianfa Zhang, Shenzhen (CN)

(72) Inventors: Xiangxing Zeng, Shenzhen (CN); Baofeng Miao, Shenzhen (CN); Xiaodan Li, Shenzhen (CN); Wu Chen, Shenzhen (CN); Xiaofei Zou, Shenzhen (CN); Xiang Zhang, Shenzhen (CN); Zhaojun Ye, Shenzhen (CN); Huatan Wu, Shenzhen (CN); Wenliang Chen, Shenzhen (CN); Lianfa Zhang, Shenzhen (CN)

(21) Appl. No.: 15/836,913

(22) Filed: Dec. 11, 2017

(51) Int. Cl. H02S 30/20; H02S 20/30

(52) U.S. Cl. CPC H02S 30/20; H02S 20/30

(57) ABSTRACT

The present invention provides a smart power supply system including an open storage chamber, a rail, and photovoltaic umbrellas each including a plurality of photovoltaic umbrella panels. The photovoltaic umbrellas may be stored in the storage chamber; the storage chamber is connected to the rail via an opening. When in use, the photovoltaic umbrellas are moved upward from the storage chamber to the rail, then photovoltaic umbrella panels of the photovoltaic umbrellas are expanded. During storage, the photovoltaic umbrella panels of the photovoltaic umbrellas are collapsed, then the photovoltaic umbrellas move downwards along the rail and are then stored in the storage chamber. In the present invention, when use of the photovoltaic umbrellas is required, the photovoltaic umbrellas are expanded outdoor; under certain circumstances such as raining and typhoon, the photovoltaic umbrellas are stored indoor to prevent damages caused to the photovoltaic umbrellas.

### BACKGROUND OF THE INVENTION

The present invention relates to a smart power supply system.

Existing photovoltaic devices are fixedly installed outdoor normally; under certain circumstances, such as raining, typhoon, as there is no way to store the photovoltaic devices indoor, therefore causing damages to the photovoltaic devices.

### BRIEF SUMMARY OF THE INVENTION

To overcome the deficiencies present in the prior art, the present invention provides a smart power supply system which is applied on roof of a building and comprises a plurality of photovoltaic umbrellas, a storage chamber for photovoltaic umbrellas, and a rail for moving the photovoltaic umbrellas; the photovoltaic umbrellas may be stored in the storage chamber; the storage chamber is connected to the rail via an opening;

when in use, the photovoltaic umbrellas are moved from the storage chamber to the rail, then photovoltaic umbrella panels of the photovoltaic umbrellas are expanded;

during storage, the photovoltaic umbrella panels of the photovoltaic umbrellas are collapsed, then the photovoltaic umbrellas move along the rail and are then stored in the storage chamber.

Furthermore, the rail comprises a recessed groove which is continuously disposed; the recessed groove has two side walls which are each provided with a sliding rail for the photovoltaic umbrellas to slide thereon; a guiding wheel assembly for sliding along the sliding rail and a first motor for driving movement of the guiding wheel assembly are provided on a bottom portion of each of the photovoltaic umbrellas; the first motor may be rotated bi-directionally; the first motor is controlled by a microcontroller of a control system. When the photovoltaic umbrellas are in use, the control system may control the first motor to rotate in a first direction to move the photovoltaic umbrellas from the storage chamber to the rail; when the photovoltaic umbrellas are collapsed and not in use, the control system controls the first motor to rotate in an opposite direction to move the photovoltaic umbrellas to the storage chamber.

Furthermore, the guiding wheel assembly comprises a connecting shaft and two guiding wheels rotatably connected at two ends of the connecting shaft; insulation layers are disposed at two ends of the connecting shafts each at a connection area between the respective connecting shaft and the corresponding guiding wheel; the guiding wheels are positioned on the sliding rail of the rail and are driven by the first motor. The guiding wheels, the rail and the connecting shaft are all made of metal; a positive terminal of the photovoltaic umbrella is connected to the connecting shaft, and the connecting shaft is connected to a positive terminal of a power storage system via conductors, thereby forming a positive path for a charging circuit; a negative terminal of the photovoltaic umbrella is connected to the guiding wheels; the guiding wheels are in direct contact with the rail, and the rail is directly installed on the ground, thereby forming a negative path for the charging circuit.

Furthermore, each of the photovoltaic umbrellas comprises a plurality of photovoltaic umbrella panels and a control system for controlling expansion and collapse of the photovoltaic umbrella panels.

Furthermore, the control system comprises control keys and a microcontroller for processing commands; the microcontroller further comprises a Bluetooth device which is communicatively connected to a Bluetooth device on the photovoltaic umbrella for transmission of commands; the microcontroller is provided with a combination of keys.

Furthermore, a movable cover is provided at an opening of the recessed groove of the rail for opening and closing of the opening; the movable cover comprises a left cover and a right cover; each of the left cover and the right cover is rotatably connected to an edge of the opening of the recessed groove; when any of the photovoltaic umbrellas is moved out along the rail, the cover is opened under pressure; after the photovoltaic umbrella has passed, the cover is closed to cover the recessed groove.

Furthermore, the photovoltaic umbrella has a bottom end which is curved inward for lifting up the cover.

Furthermore, the cover is made of plastic or stainless steel.

Furthermore, the bottom portion of each of the photovoltaic umbrellas is provided with a universal joint; the universal joint drives rotation of the photovoltaic umbrella at expanded state; the universal joint is controlled by a motor; the motor is controlled by a microcontroller; a light sensor is disposed at a side of each of the photovoltaic umbrella panels which faces the sun; the light sensor is connected to the microcontroller.

The present invention has the following advantageous effects: In the present invention, when use of the photovoltaic umbrellas is required, the photovoltaic umbrellas are expanded outdoor; under certain circumstances such as raining and typhoon, the photovoltaic umbrellas are stored indoor to prevent damages caused to the photovoltaic umbrellas.

### BRIEF DESCRIPTION OF THE DRAWINGS

FIG. 1 is a schematic view showing the smart power supply system.

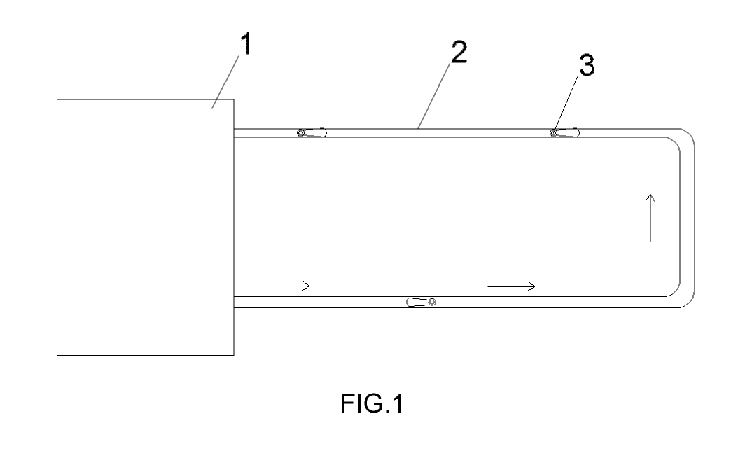

FIG. 2 is a sectional view of the rail of the smart power supply system.

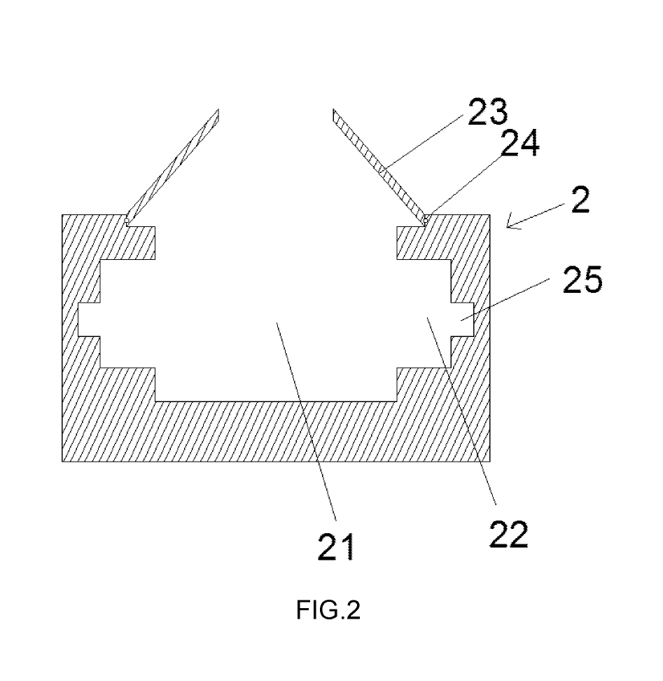

FIG. 3 is a schematic view showing assembly of the rail and the photovoltaic umbrella of the smart power supply system.

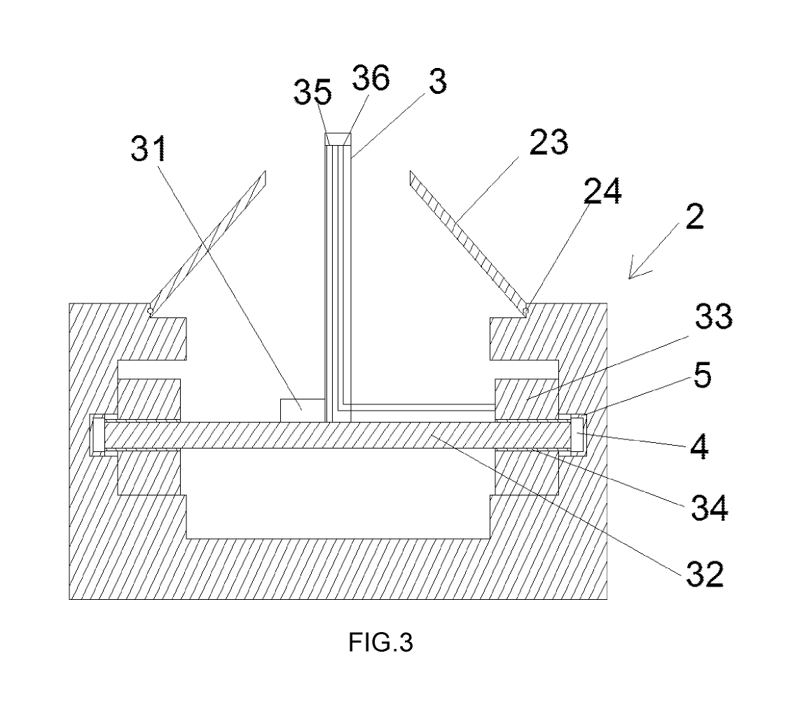

FIG. 4 is a schematic view showing the photovoltaic umbrella at expanded state.

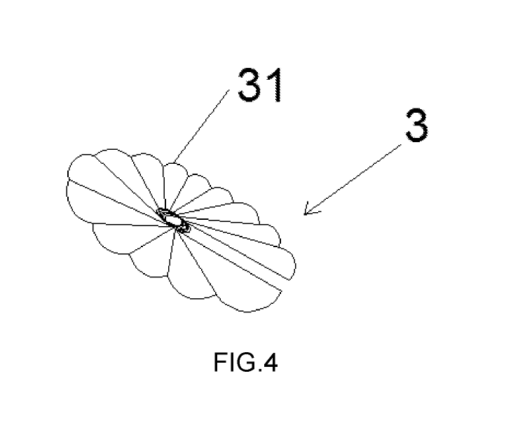

### DETAILED DESCRIPTION OF THE INVENTION

The present invention will be comprehensively described with an embodiment and the accompanying drawings, but the present invention may be implemented in various manners within the scope of the claims.

The smart power supply system of the present invention is applied on the roof of a building. It comprises a plurality of photovoltaic umbrellas 3, a storage chamber 1 for photovoltaic umbrellas, and a rail 2 for moving the photovoltaic umbrellas. The photovoltaic umbrellas 3 may be stored in the storage chamber 1. The storage chamber 1 is connected to the rail 2 via an opening.

When in use, the photovoltaic umbrellas 3 are moved from the storage chamber 1 to the rail 2, then the photovoltaic umbrella panels 31 of the photovoltaic umbrellas 3 are expanded;

During storage, the photovoltaic umbrella panels 31 of the photovoltaic umbrellas 3 are collapsed, then the photovoltaic umbrellas 3 move along the rail 2 and are then stored in the storage chamber 1.

Furthermore, the rail 2 comprises a recessed groove 21 which is continuously disposed. The recessed groove 21 has two side walls which are each provided with a sliding rail 22 for the photovoltaic umbrellas 3 to slide thereon. A guiding wheel assembly for sliding along the sliding rail and a first motor 31 for driving movement of the guiding wheel assembly are provided on a bottom portion of each of the photovoltaic umbrellas 3. The first motor 31 may be rotated bi-directionally. The first motor 31 is controlled by a microcontroller of a control system.

Furthermore, the guiding wheel assembly comprises a connecting shaft 32 and two guiding wheels 33 rotatably connected at two ends of the connecting shaft 32. Insulation layers 34 are disposed at two ends of the connecting shafts 32 each at a connection area between the respective connecting shaft 32 and the corresponding guiding wheel 33. The guiding wheels are positioned on the sliding rail 22 of the rail 2 and are driven by the first motor 21.

Furthermore, the guiding wheels 33, the rail 2 and the connecting shaft 32 are all made of metal. A positive terminal 35 of the photovoltaic umbrella 3 is connected to the connecting shaft 32, and the connecting shaft 32 is connected to a positive terminal of a power storage system via conductors 4, thereby forming a positive path for a charging circuit. A negative terminal 36 of the photovoltaic umbrella 3 is connected to the guiding wheels 33. The guiding wheels 33 are in direct contact with the rail 2, and the rail 2 is directly installed on the ground, thereby forming a negative path for the charging circuit.

Furthermore, the photovoltaic umbrella 3 comprises a plurality of photovoltaic umbrella panels 31 and a control system for controlling expansion and collapse of the photovoltaic umbrella panels. The control system comprises control keys and a microcontroller for processing commands. The microcontroller further comprises a Bluetooth device which is communicatively connected to a Bluetooth device on the photovoltaic umbrella 3 for transmission of commands. The microcontroller is provided with a combination of keys. With the aforementioned structure, the photovoltaic umbrella panels 31 may be automatically expanded and collapsed. Users may activate one of the keys in the combination of keys to cause expansion of the photovoltaic umbrella panels 31 outside the rail, and activate another one of the keys to cause collapse of the photovoltaic umbrella 3.

Furthermore, a movable cover 23 is provided at an opening of the recessed groove 21 of the rail 2 for opening and closing of the opening. The movable cover comprises a left cover and a right cover. Each of the left cover and the right cover is rotatably connected to an edge of the opening of the recessed groove 21 via a hinge 24. When any of the photovoltaic umbrellas 3 is moved out along the rail 2, the cover 23 is opened under pressure; after the photovoltaic umbrella 3 has passed, the cover 23 is closed to cover the recessed groove 2. The photovoltaic umbrella 3 has a bottom end which is curved inward for lifting up the cover 23. The cover 23 is made of plastic or stainless steel. The cover 23 is used to close the storage chamber 1 and the rail 2, thus preventing external objects from entering the storage chamber 1 to cause damages to the equipment therein and also preventing people from getting electric shock during close contact. The aforementioned structures may form a charging circuit for charging a power storage device. In the charging circuit, the conductors 4 are disposed in the rail 2 and an insulation layer 5 is provided between each of the conductors 4 and the rail 2. Each of the conductors 4 is arranged along a direction of the rail 2 and along a continuous pathway 25 within and along each of the sliding rails 22 of the rail 2. The connecting shaft 32 passes through the guiding wheels 3 and the pathways 25 to connect to the conductors 4. The aforementioned structure allows the charging circuit to remain closed when the photovoltaic umbrellas 3 are moved to any positions of the rail 2 and no wires is required, thus it is very practical.

Furthermore, the bottom portion of each of the photovoltaic umbrellas 3 is provided with a universal joint. The universal joint drives rotation of the photovoltaic umbrella 3 at expanded state. The universal joint is controlled by a third motor. The third motor is controlled by the microcontroller. A light sensor is disposed at a side of each of the photovoltaic umbrella panels which faces the sun. The light sensor is connected to the microcontroller. The light sensor is capable of detecting presence of sunlight and then transmitting a signal indicating absence or presence of sunlight to the microcontroller. The microcontroller then processes the signal. When sunlight is present, the microcontroller does not send commands, the third motor and the universal joint remain static, and the photovoltaic umbrella may continue to generate power under the presence of sunlight. When sunlight is absent, the microcontroller sends commands to control rotation of the third motor, and the third motor then drives rotation of the universal joint, and the universal joint then drives rotation of the photovoltaic umbrella 3. When the photovoltaic umbrella 3 is rotated to a position where sunlight is present, the microcontroller receives the signal and then stops sending commands, the third motor stops rotation, and the photovoltaic umbrella 3 also stops rotation. The photovoltaic umbrella 3 may rotate corresponding to the movement of sunlight, and so could absorb sunlight with the maximum surface area, thus enhancing conversion of electricity.

The aforementioned preferred embodiment does not limit the present invention. To the person skilled in the art, any modification, substitution, improvement and so forth not departing from the principle and spirit of the present invention falls within the scope of protection of the present invention.

What is claimed is:

1. A smart power supply system which is applied on roof of a building, characterized in that: it comprises a plurality of photovoltaic umbrellas, a storage chamber for photovoltaic umbrellas, and a rail for moving the photovoltaic umbrellas; the photovoltaic umbrellas may be stored in the storage chamber; the storage chamber is connected to the rail via an opening;
when in use, the photovoltaic umbrellas are moved from the storage chamber to the rail, then photovoltaic umbrella panels of the photovoltaic umbrellas are expanded;
during storage, the photovoltaic umbrella panels of the photovoltaic umbrellas are collapsed, then the photovoltaic umbrellas move along the rail and are then stored in the storage chamber.

2. The smart power supply system as in claim 1, characterized in that: the rail comprises a recessed groove which is continuously disposed; the recessed groove has two side walls which are each provided with a sliding rail for the photovoltaic umbrellas to slide thereon; a guiding wheel assembly for sliding along the sliding rail and a first motor for driving movement of the guiding wheel assembly are provided on a bottom portion of each of the photovoltaic umbrellas;
the first motor may be rotated bi-directionally; the first motor is controlled by a microcontroller of a control system.

3. The smart power supply system as in claim 2, characterized in that: the guiding wheel assembly comprises a connecting shaft and two guiding wheels rotatably connected at two ends of the connecting shaft; insulation layers are disposed at two ends of the connecting shafts each at a connection area between the respective connecting shaft and the corresponding guiding wheel; the guiding wheels are positioned on the sliding rail of the rail and are driven by the first motor.

4. The smart power supply system as in claim 3, characterized in that: the guiding wheels, the rail and the connecting shaft are all made of metal; a positive terminal of the photovoltaic umbrella is connected to the connecting shaft, and the connecting shaft is connected to a positive terminal of a power storage system via conductors, thereby forming a positive path for a charging circuit; a negative terminal of the photovoltaic umbrella is connected to the guiding wheels; the guiding wheels are in direct contact with the rail, and the rail is directly installed on the ground, thereby forming a negative path for the charging circuit.

5. The smart power supply system as in claim 1, characterized in that: each of the photovoltaic umbrellas comprises a plurality of photovoltaic umbrella panels and a control system for controlling expansion and collapse of the photovoltaic umbrella panels.

6. The smart power supply system as in claim 5, characterized in that: the control system comprises control keys and a microcontroller for processing commands;
the microcontroller further comprises a Bluetooth device which is communicatively connected to a Bluetooth device on the photovoltaic umbrella for transmission of commands; the microcontroller is provided with a combination of keys.

7. The smart power supply system as in claim 2, characterized in that: a movable cover is provided at an opening of the recessed groove of the rail for opening and closing of the opening; the movable cover comprises a left cover and a right cover; each of the left cover and the right cover is rotatably connected to an edge of the opening of the recessed groove; when any of the photovoltaic umbrellas is moved out along the rail, the cover is opened under pressure; after the photovoltaic umbrella has passed, the cover is closed to cover the recessed groove.

8. The smart power supply system as in claim 7, characterized in that: the photovoltaic umbrella has a bottom end which is curved inward for lifting up the cover.

9. The smart power supply system as in claim 7, characterized in that: the cover is made of plastic or stainless steel.

10. The smart power supply system as in claim 1, characterized in that: a bottom portion of each of the photovoltaic umbrellas is provided with a universal joint; the universal joint drives rotation of the photovoltaic umbrella at expanded state; the universal joint is controlled by a motor; the motor is controlled by a microcontroller; a light sensor is disposed at a side of each of the photovoltaic umbrella panels which faces the sun; the light sensor is connected to the microcontroller.
